(19) United States
(12) Patent Application Publication
(10) Pub. No.: US 2004/0156394 A1
(43) Pub. Date: Aug. 12, 2004

(54) Handling of user identity

(76) Inventor: Ilkka Westman, Helsinki (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/758,017

(22) Filed: Jan. 16, 2004

Related U.S. Application Data
(60) Provisional application No. 60/445,873, filed on Feb. 10, 2003.

(51) Int. Cl. H04J 3/24

(52) U.S. Cl. 370/471; 370/392

(57) ABSTRACT

Implementing interworking of addressing schemes in a communication network using at least two different addressing schemes, wherein a first address according to a first addressing scheme is obtained and a second address according to a second addressing scheme is provided by including the first address into the second address such that the first address is represented in the second address. Moreover, an indication is provided that part of the second address represents the first address.

The present application claims the benefit of priority of Provisional Application Serial No. 60/445,873, filed Feb. 10, 2003, the contents of which are incorporated herein by reference.

### FIELD OF THE INVENTION

The present invention relates to handling a user identity in translating a first addressing scheme into a second addressing scheme. In particular, the present invention relates to mapping E.164 numbers into Uniform Resource Identifiers (URIs) using an ENUM (Telephone Number Mapping) translation. Furthermore, the invention relates to transferring user identity in the communication network.

### BACKGROUND OF THE INVENTION

ENUM is a function for mapping E.164 numbers e.g., into Uniform Resource Identifiers (URIs) corresponding to communication applications associated with those numbers. ENUM utilizes the protocol developed by the Internet Engineering Task Force (IETF), specified in RFC 2916 that first transforms E.164 numbers into ENUM domain names and then uses the DNS (Domain Name System) based architecture to access records from which the URIs are derived. ITU-T Recommendation E.164, titled “The International Public Telecommunications Numbering Plan,” describes the format and types of use of public E.164 numbers.

Through the ENUM function, E.164 numbers can be used to provide calling users with a variety of addresses, including those used for phone, fax and email, by which the called user can be contacted. This enables the called user to tailor the manner in which they are contacted through a single number. Contact information can also be easily amended, added to, or updated without changing the number used for access.

It can be seen from FIG. 1 that an SCN (Switched Circuit Network) based user (E.164 number: 1 908 555 1234) can contact a user on an IP (Internet Protocol) based network through the use of the called user's E.164 number (35840223344). In a first step the SCN-based user dials the telephone number +35840223344. In the SCN the call is routed to a gateway in a second step and the gateway signals the call to its gatekeeper in a third step. In a fourth step, the gatekeeper queries the DNS (Domain Name System) using domain name 4.4.3.3.2.2.0.4.8.5.3.e164.TLD (TLD=Top Level Domain). Then, in a fifth step, the DNS returns an URI h323:user@gk.foo to the gatekeeper. The gatekeeper resolves h323:user@gk.foo to the IP address of the terminal using its back-end service in a sixth step. Finally, in a seventh step, the gatekeeper routes the call to the IP based voice terminal.

In other words, when the SCN initiated call reaches an ENUM enabled gatekeeper, it formats the number into the ENUM domain name 4.4.3.3.2.2.0.4.8.5.3.e164.TLD and the DNS returns the URI related to the required H.323 user (h323:user@gk.foo). Another look-up in the Back-End service is then required to look up the IP address for the subscriber's terminal. The call can then be completed to the H.323 client (terminal) related to the E.164 number (35840223344). In the H.323 environment, a gatekeeper is the controlling element within a specific H.323 environment and it controls a number of gateways in this H.323 domain.

There are many applications of the Internet that require the creation and management of a session, where a session is considered an exchange of data between an association of participants. The implementation of these applications is complicated by the practices of participants: users may move between endpoints, they may be addressable by multiple names, and they may communicate in several different media sometimes simultaneously. Numerous protocols have been authored that carry various forms of real-time multimedia session data such as voice, video, or text messages. The Session Initiation Protocol (SIP) works in concert with these protocols by enabling Internet endpoints (called user agents) to discover one another and to agree on a characterization of a session they would like to share. For locating prospective session participants, and for other functions, SIP enables the creation of an infrastructure of network hosts (called proxy servers) to which user agents can send registrations, invitations to sessions, and other requests. SIP is an agile, general-purpose tool for creating, modifying, and terminating sessions that works independently of underlying transport protocols and without dependency on the type of session that is being established. SIP is an application-layer control protocol that can establish, modify, and terminate multimedia sessions (conferences) such as Internet telephony calls.

FIG. 2 shows a typical PSTN-IP call flow using SIP.

It can be seen from FIG. 2 that a PSTN (Public Switched Telephone Network) based user (number +1 908 555 1234) can contact a user on an IP-based network through the use of the called user's E.164 number (+35840223344). In a first step the PSTN-based user dials the called user's number +35840223344. In a second step, the PSTN or SCN routes the call to a gateway comprising a media gateway control function (MGCF). The gateway formats the number into the ENUM domain name in a third step, and, in a fourth step, a gatekeeper queries DNS (Domain Name System) using the ENUM domain name, and the DNS look up yields a NAPTR (Naming Authority Pointer) record with sip:user@sipsrvc.foo in a fifth step. It is to be noted that the DNS lookup may return none, one or several NAPTR DNS resource records one of which is selected. Then, in a sixth step, the gateway looks up host for the address user@sipsrvc.foo, and the DNS returns the IP address of the SIP server in a seventh step. After that, the gateway routes the call to the resolved SIP server in an eighth step and finally, in a ninth step, the SIP server routes the call to the IP-based user.

In other words, when the PSTN initiated call reaches an ENUM enabled gateway, the gateway formats the number into the ENUM domain name 4.4.3.3.2.2.0.4.8.5.3.e164.TLD and the DNS returns the URI related to the required SIP user (sip:user@sipsrvc.foo). Another DNS look-up is then required to look up the host for user@sipsrvc.foo and the SIP server IP address is returned. The call can then be completed to the SIP client (terminal) related to the E.164 number +35840223344.

Through transformation of E.164 numbers into DNS names and the use of existing DNS services like delegation through NS (Name Server) records, and use of NAPTR (Naming Authority Pointer) records in DNS, one can look up what services (for example, e-mail, voice call) are available for a specific domain name in a decentralized way with distributed management of the different levels in the lookup process.

The domain “e164.arpa” is being populated in order to provide the infrastructure in DNS for storage of E.164 numbers. In order to facilitate distributed operations, this domain is divided into subdomains. Holders of E.164 numbers which want to be listed in DNS should contact the appropriate zone administrator in order to be listed, by examining the SOA (Start Of Authority) resource record associated with the zone, just like in normal DNS operations.

To find the DNS names for a specific E.164 number, the following procedure is to be followed according to RFC 2916:

1. See that the E.164 number is written in its full form, including the country code IDDD. Example: +358-40-223344

2. Remove all non-digit characters with the exception of the leading ‘+’. Example: +35840223344

3. Remove all characters with the exception of the digits. Example: 35840223344

4. Put dots (“.”) between each digit.

Example: 3.5.8.4.0.2.2.3.3.4.4

5. Reverse the order of the digits.

Example: 4.4.3.3.2.2.0.4.8.5.3

6. Append the string “.e164.arpa” to the end.

Example: 4.4.3.3.2.2.0.4.8.5.3.e164.arpa

For a record in DNS, the NAPTR record is used for identifying available ways of contacting a specific node identified by that name. Specifically, it can be used for knowing what services exist for a specific domain name, including phone numbers by the use of the e164.arpa domain as described above.

The input into the ENUM algorithm is an E.164 encoded telephone number. The output is a Uniform Resource Identifier (URI). An E.164 number without any characters but leading ‘+’ and digits (result of step 2 above) is the input to the NAPTR algorithm.

The above operation is used to map one E.164 number to a list of URIs. For example, a DNS look up on the basis of an E.164 number +35840223344 returns a NAPTR record of $ORIGIN 4.4.3.3.2.2.0.4.8.5.3.e164.arpa.

IN NAPTR 10 10 “u” “sip+E2U” “!\hat{ }.*$!sip:john.smith@ims.operator1.fi!”

IN NAPTR 102 10 “u” “tel+E2U” “!\hat{ }.*$!tel:+358401223344!”

when applied to the +35840223344 they yield to sip:john.smith@ims.operator1.fi and tel:+358401223344, respectively. Because SIP URI is wanted as a result the first NAPTR record is selected and the result when the selected NAPTR is applied is sip:john.smith@ims.operator1.fi. However, from the result the original E.164 cannot be extracted. The next step in the resolution process is to use the resolution mechanism for an indicated protocol, SIP in this example, to know what node to contact for the protocol.

For more details about ENUM, NAPTR and SIP it is referred to ITU-T E.164 Supplement, “Operational and administrative issues associated with national implementations of the ENUM functions”, May 2002; P. Faltstrom, “E.164 number and DNS”, RFC 2916, September 2000; M. Mealling and R. Daniel, “The Naming Authority Pointer (NAPTR) DNS Resource Record”, RFC 2915, September 2000; and J. Rosenberg et al., “SIP: Session Initiation Protocol”, RFC 3261, June 2002.

As can be understood from the above, when a call is originated in a circuit switched (CS) network (e.g., PSTN) and it is terminated in a packet switched or IP based network, e.g., SIP based network, the address formats in these two networks are different. Media Gateway Control Function (MGCF) is required between the circuit switched network and the SIP based network. Between a CS user and the MGCF, the signaling is ISUP (ISDN User Part, ISDN=Integrated Services Digital Network), and the address format is E.164, like 35840223344. Between the MGCF and a called user the signaling relates to an IP protocol, such as SIP, and the address format is name@domain, like firstname.lastname@ims.operator1.fi, for example.

In addition, a SIP user can initiate a session to another SIP user using an E.164 number of another party. In this case, the E.164 number must be correspondingly converted into a SIP URI because the E.164 number is not routable in a SIP based network, as stated before. In this scenario, there is no MGCF involved in call setup and the address translation must be made elsewhere. For example, in 3GPP IMS network the translation is performed by CSCF (Call Session Control Function or Call State Control Function).

In ISDN, there is a feature called connected line identification presentation (COLP). This is a supplementary service offered to the calling party which provides the connected party's ISDN number, with additional address information (e.g., connected party sub-address) if any, to the calling party at the call establishment phase. In other words, the caller is enabled to see the connected number in the display of his terminal. Of course, usually the caller knows to whom he is calling but, for example, if call forwarding or call transfer occurs, the call is connected to a third party. If number portability is applied, the call is connected to a new number normally subscribed from another operator. According to COLP, the connected number may be delivered from the connected user (originally called party or party after forwarding, call transfer or number portability or the like) to the caller in some early backward message. For more details it is referred to the Specification ITU-T Q.731.5.

Information about the connected address is transferred from the connected user to the caller in signaling messages. As stated, the used signaling is ISUP between the caller and MGCF. A drawback of ISUP is that it is not capable of carrying address information that comprises other characters than only digits (0 . . . 9). In ISUP, addresses must be presented according to E.164 specification. However, when the call progresses in the SIP based network behind the MGCF, the addresses are usually presented by a combination of a user name and a domain name (e.g., ‘sip:username@sip.operator.net’). In case of circuit switched originated call, a called E.164 address from ISUP is converted into SIP routable SIP-URI using ENUM translation in the MGCF or in other network element (e.g., in I-CSCF) if configured routing is used to route from MGCF to I-CSCF. When the call is connected to the called user, the network node that controls the called user sends the called address as a connected address in a SIP backward message towards the calling user. This address could then be shown to the caller as a connected number. However, the feature works only in pure SIP environment. At the moment, the MFCF does not try to extract the connected number from SIP messages because the address is useless in ISUP for above presented reason (only digits 0 . . . 9 can be used in ISUP). Hence, the connected address cannot be shown to the circuit switched caller in current implementations, when the call terminates to the SIP based network.

Furthermore, if a call is forwarded or transferred in the SIP based network, the new address, so-called C address, has been given by an originally called user. If number portability is applied, the new address may be obtained from a number portability device or system. This new address could also be in a SIP format (username@domain). So, the address is not even valid for presenting it to the calling circuit switched user, since there is no E.164 compatible address anywhere. In addition, the SIP based network does not know that the calling user is located in the circuit switched network. Moreover, it can be noted in this connection, that the ENUM translation is not applicable to translate the SIP-URI into E.164 address in the MGCF or other network element.

The network node that controls the called user could try to insert an E.164 number of the called user as an additional identity in a SIP backward message towards the calling user. This address could then be shown to the caller as a connected number, if MGCF was capable to extract it out of the SIP message. A drawback of this proposal is difficulties in selecting E.164 number in case the called user has several E.164 numbers. Another drawback is that whatever the chosen E.164 is, it is not the actual connected address, which is SIP URI of format username@domain.

### SUMMARY OF THE INVENTION

It is an object of the invention to improve interworking between different addressing schemes.

According to the invention, this object is achieved by a method of implementing interworking of addressing schemes according to claim 1, a network node according to claim 18 and a communication network according to claim 37.

Further features of the present invention are defined in the dependent claims.

According to an embodiment of the invention, interworking between an addressing scheme used in IP based networks and an E.164 addressing scheme used, for example, in a circuit switched network, is improved.

According to the embodiment, the correct connected line identity (so-called, SIP Called Party Identity, CPI) can be presented to a calling subscriber in the circuit switched network when a call is terminated in SIP based network, for example, IMS (IP Multimedia Subsystem defined by 3GPP (Third Generation Partnership Project)). In particular, using the principles of the present invention, ENUM returns such NAPTR resource records that after applying the ENUM algorithm the result is always a SIP URI representation of the original E.164 number such that the original E.164 number can be extracted from the SIP URI representation whenever needed, for example, when the same or a new address is later returned in a backward message as a connected address.

A further advantage of the present invention is that, in principle, only one NAPTR resource record is required for the whole number range while every number would need an own NAPTR if the ENUM translation result was a pure SIP URI. This results in smaller ENUM databases.

### BRIEF DESCRIPTION OF THE DRAWINGS

FIG. 1 shows a call flow from switched circuit network to IP based network.

FIG. 2 shows a call flow from PSTN to IP using SIP.

FIG. 3 shows a flow chart illustrating an addressing schemes interworking process according to the present invention.

FIG. 4 shows a schematic block diagram illustrating a communication network according to the present invention.

FIGS. 5 and 6 show schematic signaling diagrams illustrating an embodiment of the present invention.

FIGS. 7 to 12 show schematic diagrams of routing examples according to the invention.

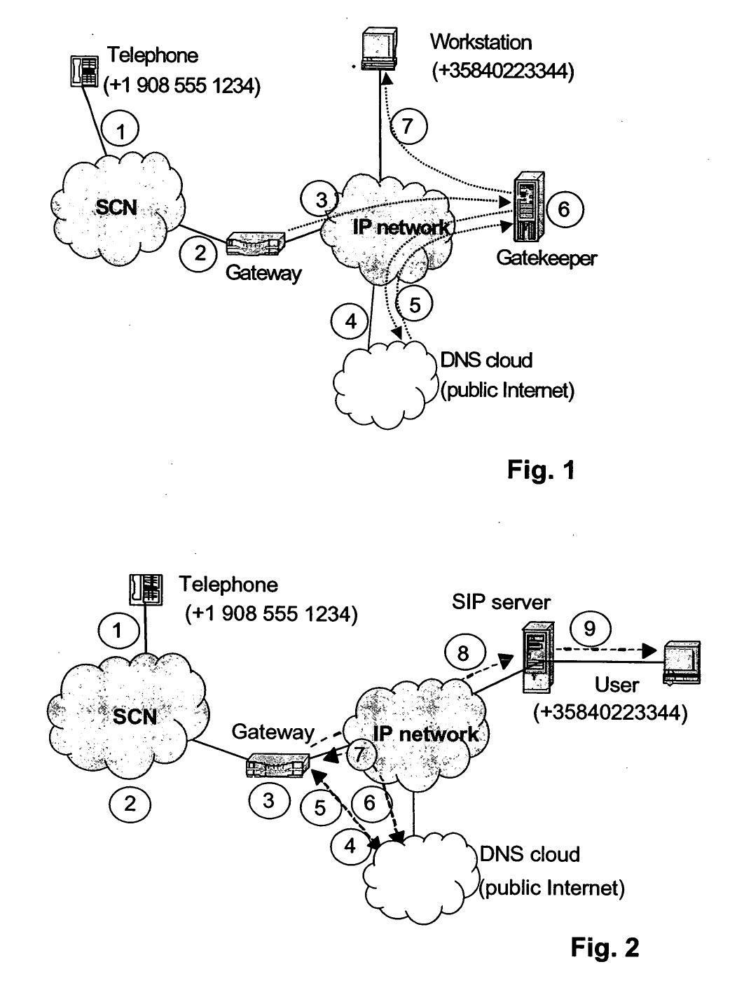

### DESCRIPTION OF THE PREFERRED EMBODIMENT

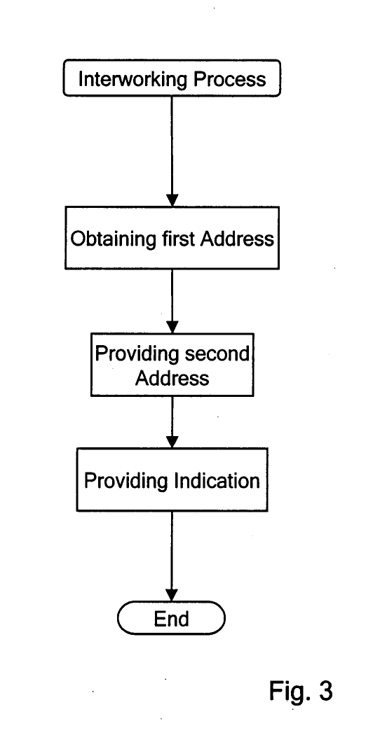

FIG. 3 shows a flow chart illustrating a process of implementing interworking of addressing schemes in a communication network using at least two different addressing schemes. In a first step, a first address according to a first addressing scheme is obtained. Then, in a second step, a second address according to the second addressing scheme is provided by including the first address into the second address such that the first address is represented in the second address. Finally, in a third step, an indication is provided that part of the second address represents the first address.

Upon a query on the basis of an address according to the first addressing scheme, the interworking process may return a corresponding address formed according to the second addressing scheme and the indication that part of the address according to the second addressing scheme represents the corresponding address according to the first addressing scheme. Alternatively, the indication that part of the address according to the second addressing scheme represents the corresponding address according to the first addressing scheme may be added to the second address after the second address has been returned.

The address returning step may be performed by using an identity translation mechanism, such as an ENUM translation process.

The indication that part of the second address represents the first address may be part of the second address, and may be, for example, a parameter, a character, a character string or the like, or an ordered or not ordered combination of the mentioned indications. The indication does not necessarily have to be in connection of the address. It can also be, for example, a certain flag or bit that is later added in the signaling message.

The returned second address may be sent further in a first signaling message. In response to the first signaling message at least one responding signaling message may be received, and in the received message an indication may be detected that the message includes an address according to the second addressing scheme which includes an address that can be presented according the first addressing scheme.

Subsequently, the address according to the first addressing scheme may be extracted out of said address according to the second addressing scheme, and the extracted address may be sent in a second signaling message. The extracted address may be an address of a connected user.

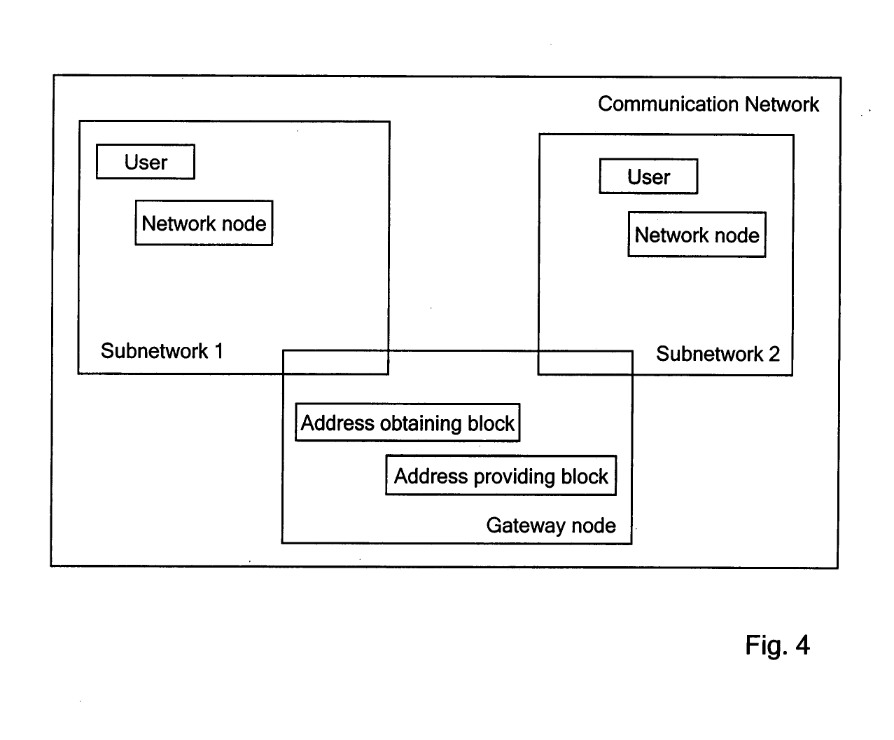

FIG. 4 shows a schematic block diagram of a communication network according to the invention. The communication network comprises at least two subnetworks, at least one network node in each subnetwork, at least one user in each subnetwork and a gateway node interfacing the at least two subnetworks. A subnetwork 1 may use a first addressing scheme routable in the first subnetwork, and a subnetwork 2 may use a second addressing scheme routable in the second subnetwork. The gateway node may comprise an address obtaining block for obtaining a first address according to the first addressing scheme, and an address providing block for providing a second address according to the second addressing scheme by including the first address into the second address such that the first address is represented in the second address and for providing an indication that part of the second address represents the first address.

The gateway node may use an address translation node when providing the second address, which address translation node may be located in the communication network and may perform the address translation using an identity translation such as ENUM, for example.

The gateway node may further receive the first address in a signaling message from the first subnetwork and may send the second address in a signaling message to the second subnetwork. A user of the second subnetwork may send, in response to a received initiating signaling message, the connected address in a response signaling message. A network node of the second subnetwork which network node controls the user of the second subnetwork may send in response to the received initiating signaling message the address of the user in a response signaling message.

Subsequently, the gateway node may receive the at least one response signaling message from the second subnetwork and detect in said received message an indication that the message includes an address according to the second addressing scheme which includes an address that can be presented according the first addressing scheme. The gateway node may further extract said address according to the first addressing scheme out of said address according to the second addressing scheme, and may send the extracted address in a signaling message to the first subnetwork.

The gateway node may be a network node of either subnetwork. For example, it may be a CSCF of either subnetwork. Alternatively, the gateway node may be a MGCF. Moreover, the gateway node may be a BGCF, an application server (AS), a multimedia message service center (MMSC) or short message service center (SMSC).

The communication network may comprise a storage block (not shown) which stores rules or algorithms for forming the second address. Such algorithms may be located as records in databases. For example, the algorithm for forming the second or IP based address may be defined in a NAPTR resource record which is returned in response to an ENUM translation and DNS look up on the basis of the address according to the first or CS based address.

The returned address according to the second address format can then be resolved into the address according to the first address format using the indication that part of the second address format represents the first address format, and the resolved first address can be returned as connected number to an entity which initiated the query.

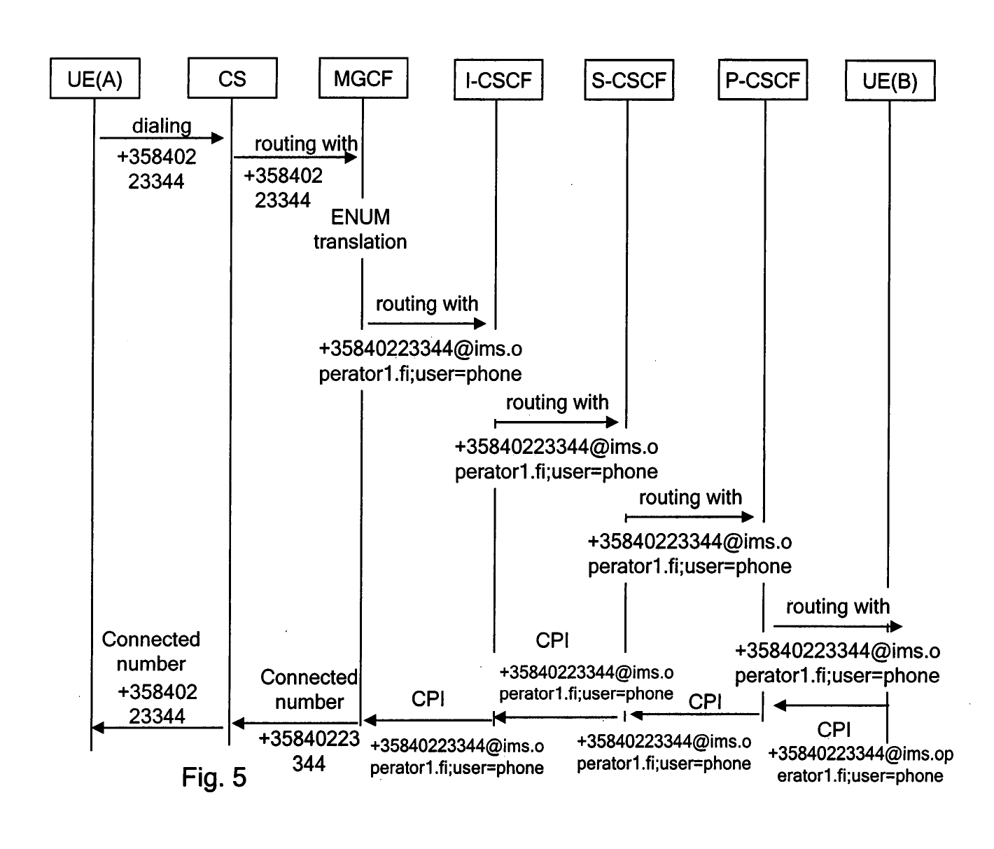

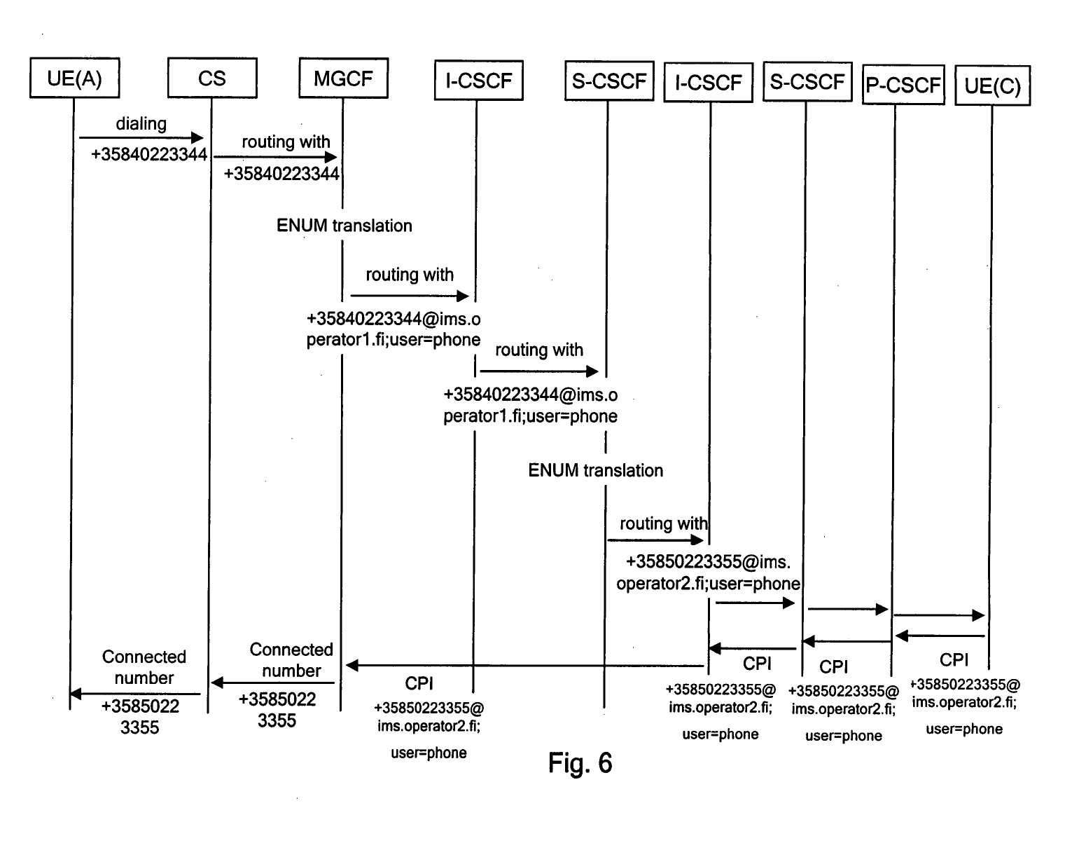

In the following, an embodiment of the invention will be described with reference to FIGS. 5 and 6, in which a user A with user equipment UE(A) tries to call a user B at user equipment UE(B). It is to be noted that in the following the term call is used which may also have the meaning of session or transaction.

The user equipment (UE) A originates a call from a circuit switched (CS) network, e.g., PSTN, and the call is terminated in an IP based network, e.g. in SIP based network. Between UE(A) and a MGCF which interfaces the CS network and the SIP based network the used signaling is ISUP and the addressing scheme is E.164, like +35840223344. Between the MGCF and UE(B) the signaling is SIP and the addressing scheme could be SIP URI or TEL URL, for example, ‘sip:firstname.lastname@ims.operator1.fi’or ‘sip: +35840223344@ims.operator1.fi’ or ‘tel:+35840223344’.

According to the prior art, a subscriber normally has two identities, i.e., E.164 (TEL URL) and name@domain (pure SIP URI). For example, a subscriber normally has ‘tel:+35840223344’ and ‘sip:firstname.lastname@ims.operator1.fi’. Instead of ‘sip:firstname.lastname@ims.operator1.fi’ the subscriber may have ‘sip:+35840223344@ims.operator1.fi’. In the ENUM translation process at the MGCF, if the TEL URL is translated to a normal SIP URI, the corresponding subscriber identity cannot be shown in the CS network as E.164 when required. In other words, the formats ‘sip:firstname.lastname@ims.operator1.fi’ and ‘sip:+35840223344@ims.operator1.fi’ are not valid for ISUP.

However, in the address ‘sip:+35840223344@ims.operator1.fi’ the actual E.164 number can be seen, but the MGCF cannot know if it really represents the E.164 number. Normally, it is considered to be just a text string. Hence, the MGCF could extract the E.164 number into an ISUP connected number parameter in an ANM (answer) or CON (Connect) backward message, but to be able to do this, the MGCF must somehow know to look the E.164 address in the SIP URI.

According to the present invention, the ENUM translation result for the identity ‘tel:+35840223344’ is always ‘sip:+35840223344@ims.operator1.fi;user=phone’. Generally speaking, E.164 always is translated to E.164@domain; user=phone which is equivalent with E.164. The indication or parameter ‘user=phone’ is used to indicate to the MGCF that the E.164 number of a connected user is included in the ‘user’ part of the SIP URI (the part before ‘@’-character) and that the MGCF should resolve the E.164 number of connected user into ISUP connected number. Moreover, the parameter ‘user=phone’ is information for an l-CSCF (Interrogating CSCF) and an HSS (Home Subscriber Server) to resolve what is the correct public user identity. The domain part is always valid for routing. In other words, E.164 scheme or a ‘user=phone’ parameter used together with SIP scheme is used to indicate to network nodes that a call leg, i.e., a dialogue in SIP, is originated using E.164 as target identity and, hence, all the network nodes should keep the identity and further possible third identities in such a format that the E.164 number is present and can be resolved.

Hence, according to the invention, ENUM returns such NAPTR resource records that after the ENUM algorithm has been applied the result is always a routable SIP URI representation of the original E.164 so that the SIP URI representation can be translated back to the original E.164 whenever needed. For this purpose, the DNS databases where NAPTR records are extracted from are modified such that upon a DNS query on the basis of an E.164 identity a routable IP or SIP identity with the format “E.164@domain; user=phone” is returned. In other words, according to the invention the following NAPTR record is used $ORIGIN 4.4.3.3.2.2.0.4.8.5.3.e164.arpa. IN NAPTR 10 10 “u” “sip+E2U” “!(\hat{ }.*$)!sip:\1@ims.operator1.fi;user=phone!”

The result when this NAPTR is applied is sip:+35840223344@ims.operator1.fi;user=phone. The parameter “user=phone” indicates that the user part (before @ sign) contains a phone number. Thus from the result the original E.164 can be extracted.

This rule is followed throughout the call, e.g., when the identity is forwarded or transferred to an identity of another user or the identity is a target of a number portability procedure where the identity is changed to another identity. In other words, two types of identities are not mixed in the same call when porting, forwarding or translating E.164 to SIP URI with ENUM, i.e., only these are allowed: E.164 →E.164 and SIP URI →SIP URI. Therefore, E.164 is always converted in ENUM translation to SIP URI representation of the original E.164, which SIP URI representation of E.164 can always be converted back to E.164 based on the indication described above.

According to the invention, the correct connected line identity can be shown to the calling user located in the CS network.

FIG. 5 shows a situation in which the CS based user A calls the SIP based user B by dialing the E.164 number +35840223344. In the CS network the call is routed with this E.164 number. At the MGCF, ENUM is used to translate the E.164 address to SIP URI. Translation may also be done at I-CSCF. Translation may be done with ENUM or with other means depending on whether it is done at the MGCF or I-CSCF. If translation is done at I-CSCF, configured routing is utilized to route the signaling from MGCF to I-CSCF. According to the invention, the ENUM translation yields the SIP URI ‘E.164@domain; user=phone’, i.e., ‘+35840223344@ims.operator1.fi; user=phone’, wherein ‘ims.operator1.fi’ is an example for an IMS domain. In the SIP based network the call is routed with ‘+35840223344@ims.operator1.fi; user=phone’ from the MGCF to UE(B) via an I-CSCF, S-CSCF (Serving CSCF) and P-CSCF (Proxy CSCF), for example. Routing to P-CSCF and/or UE(B) may not necessarily be done with ‘+35840223344@ims.operator1.fi; user=phone’, IP address may be used instead. When the called user answers, the IMS network returns the connected identity in the ‘called party ID (CPI)’ SIP URI of the corresponding SIP response message. As shown in FIG. 5, the response message is routed from UE(B) to the MGCF via the P-CSCF, S-CSCF and I-CSCF. However, in case the I-CSCF drops itself from the path, the response message may be routed directly from the S-CSCF to the MGCF. CPI may be absent in the response messages from UE(B) to P-CSCF and/or from P-CSCF to S-CSCF. After having received a response from the IMS network, the MGCF resolves the Called Party Identity from the SIP URI of the response using the indication ‘user=phone’, and signals it to the user A as a connected number, i.e., the MGCF resolves the actual connected number +35840223344 from the SIP URI and maps it into a standard ISUP connected number parameter in an ANM (answer) or CON (Connect) message.

FIG. 6 shows a situation in which a session setup (e.g., INVITE according to SIP) is sent from an IMS network to another IMS network. In other words, FIG. 6 shows the case in which the call originated by the user A is forwarded to a third party UE(C). According to FIG. 6, the user A initiates a call to the user B by dialing the E.164 number +35840223344. The call is routed with the E.164+35840223344 to the MGCF which translates the E.164 to the SIP URI ‘+35840223344@ims.operator1.fi; user=phone’ as described in connection with FIG. 5. Here again I-CSCF may do the translation instead of the MGCF similarly as described with respect to FIG. 5. In the IP network, the call is routed further with ‘+35840223344@ims.operator1.fi; user=phone’. At the S-CSCF or HSS (Home Subscriber Server) associated with the user B it is determined that the call has to be directed to the third party UE(C) with the identity ‘+35850223355’. Subsequently, the S-CSCF associated with the user B performs an ENUM translation the result of which is in the format ‘E.164@domain; user=phone’, e.g., ‘+35850223355@ims.operator2.fi; user=phone’. Then, the call is routed further with ‘+35850223355@ims.operator2.fi; user=phone’ to UE(C). Upon accepting the call the third party UE(C) sends back a response message to the MGCF via its P-CSCF, S-CSCF and I-CSCF and possibly also via S-CSCF and I-CSCF of the network of UE(B) depending on how the forwarding signaling is implemented. S-CSCF and I-CSCF of the network of UE(B) for example may drop themselves from the path because of forwarding. This is the case in FIG. 6. As described with respect to FIG. 5, in case the I-CSCF drops itself from the path, the response may be routed directly from the second S-CSCF to the first S-CSCF and from the first S-CSCF to the MGCF, respectively. The MGCF detects the ‘user=phone’ indication and the connected number +35850223355 is resolved out of the called party identity SIP URI ‘+35850223355@ims.operator2.fi; user=phone’ and is mapped into a standard ISUP connected number parameter in an ANM (answer) or CON (Connect) message.

The present invention may be implemented in an entity of a communication network system which entity interfaces an E.164 network and an IMS network, e.g., an MGCF or, alternatively, an I-CSCF, and/or in an entity of the communication network system which entity interfaces a first IMS network and a second IMS network, e.g., an S-CSCF or I-CSCF.

Therefore, according to the invention the correct connected line identity can be presented to a calling subscriber in the circuit switched network when a call is terminated in SIP based network, more particular in IMS (IP Multimedia Subsystem defined by 3GPP). Furthermore, the invention is useful also when an IP based user (e.g., a SIP user) initiates a call using E.164 to another IP based user. The connected address could be shown to the caller in E.164 format despite that the routing is done completely using IP based addressing schemes.

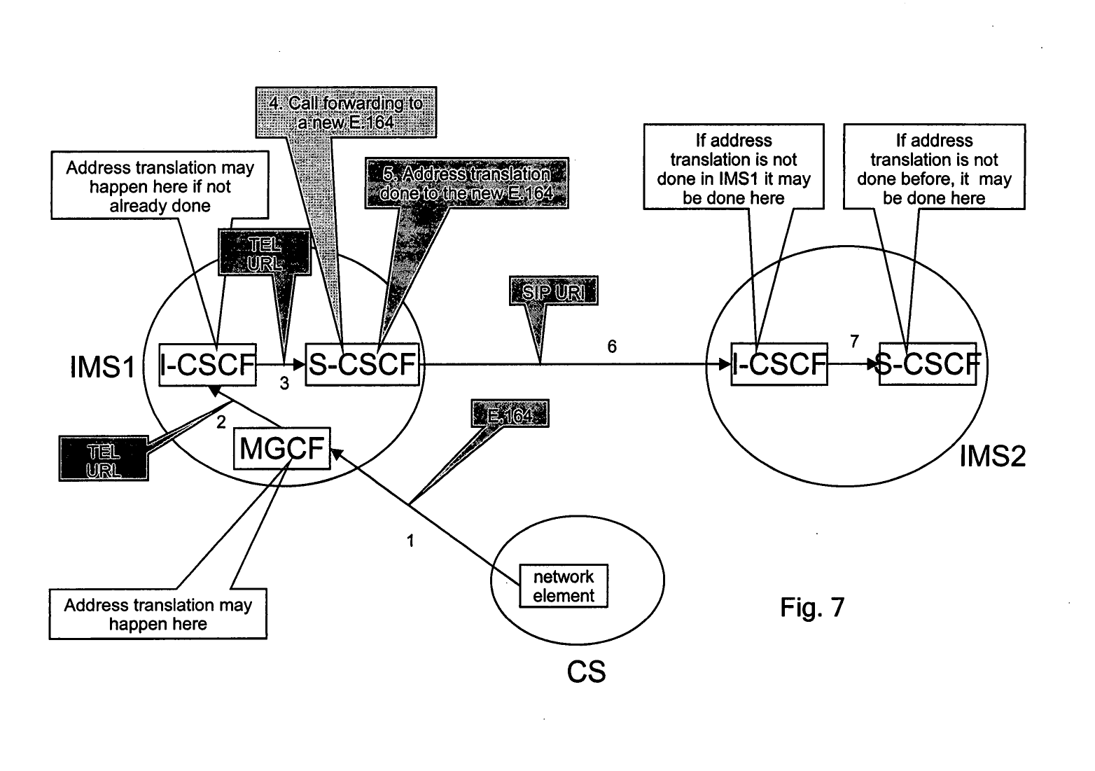

FIGS. 7 to 12 show routing examples according to the present invention. There may be two tendencies in implementing the invention with respect to E.164 and SIP addressing schemes as follows.

1. Always Use SIP URI

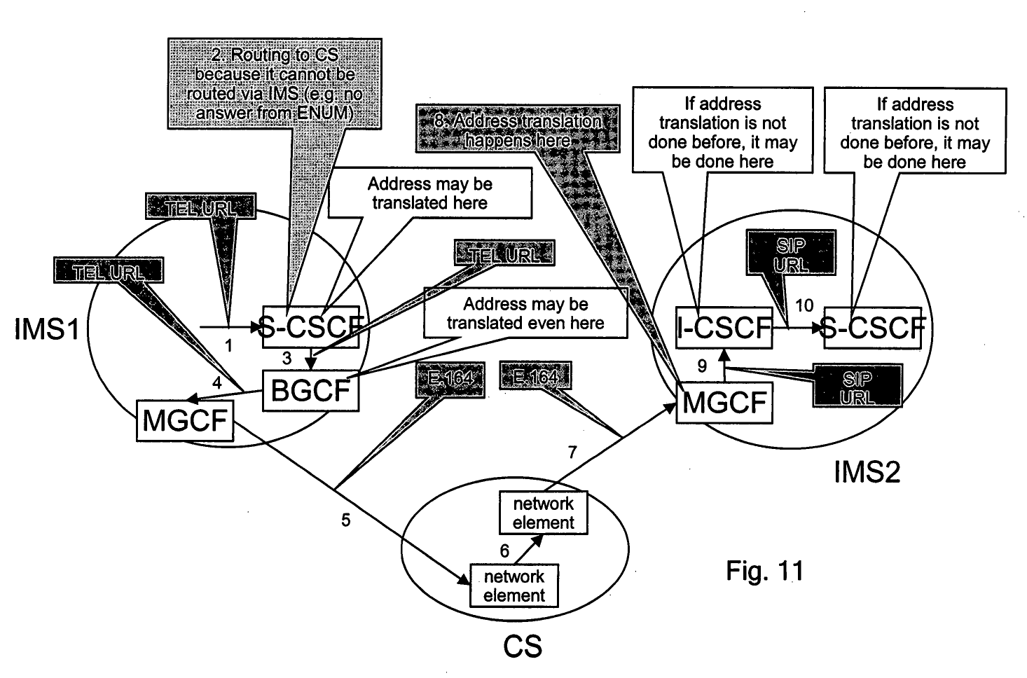

TEL URL (TELephony Uniform Resource Locator) is translated into SIP URI as soon as possible even if configured routing could be used. In other words, SIP URI is used regularly. Examples where this translation could be done are MGCF in terminating network (IMS2) as shown in FIG. 11, or S-CSCF and/or BGCF (Breakout Gateway Control Function or Border Gateway Control Function) in originating network (IMS1) (FIG. 11).

2. Tolerate Also TEL URL

TEL URL is translated into SIP URI when needed, e.g., when there is no configured routing available and correct routing has to be found. Configured routing can be used in many places, and translation can be avoided because of routing. Examples are

MGCF →I-CSCF (FIG. 7)

I-CSCF →S-CSCF (FIG. 7)

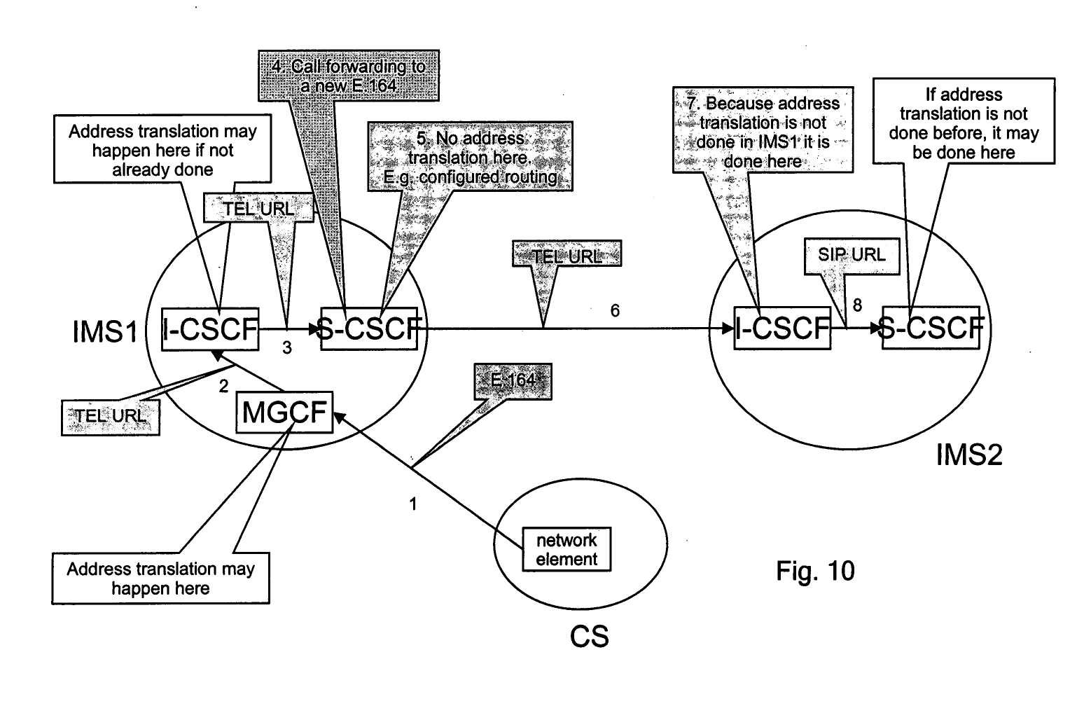

IMS →IMS, in case IMS networks are the same network (FIG. 10).

FIG. 7 shows a routing example for forwarding a call initiated by a network element located in a CS network towards a network IMS1. As shown in FIG. 7, the address translation for translating the E.164 addressing scheme according to the invention may be done in a MGCF or I-CSCF of IMS1, or within the IMS1 network the call may be routed using TEL URL addressing scheme. At an S-CSCF of IMS1 call forwarding occurs to a new E.164 number, and the address translation of the new E.164 number according to the invention is done at the S-CSCF of IMS1. Then the call is routed to a network IMS2 using SIP URI. Alternatively, if address translation of the new E.164 number has not been done already in IMS1, it may be done in I-CSCF or S-CSCF of IMS2 as shown in FIG. 10.

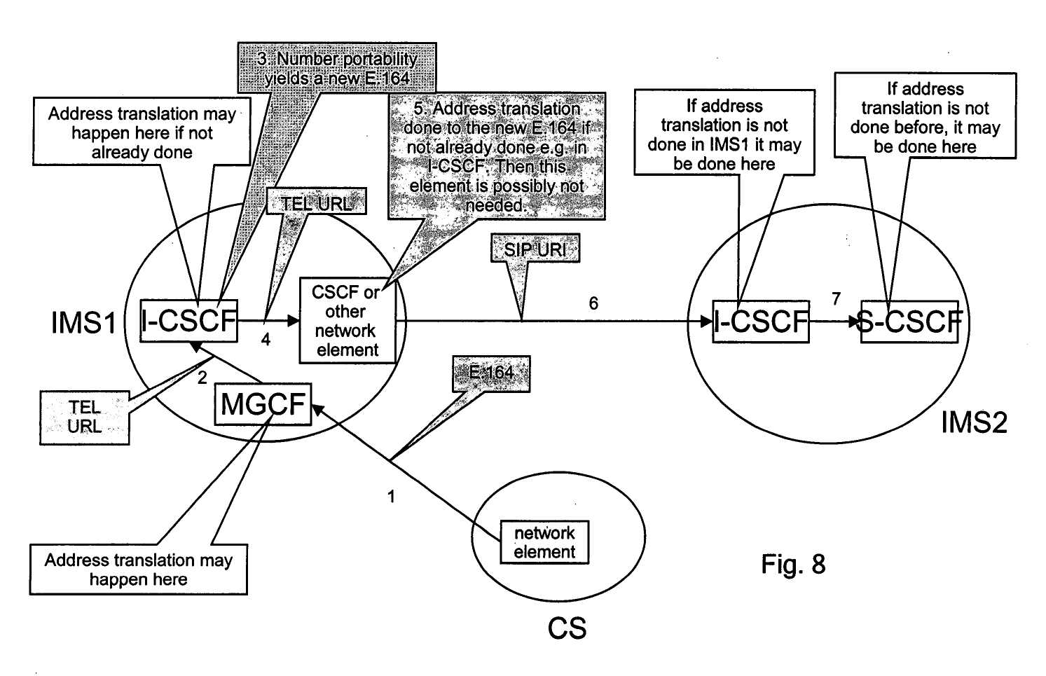

FIG. 8 shows a routing example in a number portability case in which a number portability yields a new E.164 number at the I-CSCF of IMS1. The I-CSCF of IMS1 may then perform the address translation of the new E.164 number according to the invention. Alternatively, the address translation of the new E.164 number may be performed in a CSCF or other network element of IMS1. However, if the I-CSCF has already performed the translation, this other network element may not be required. The further components and processes shown in FIG. 8 correspond to those in FIG. 7.

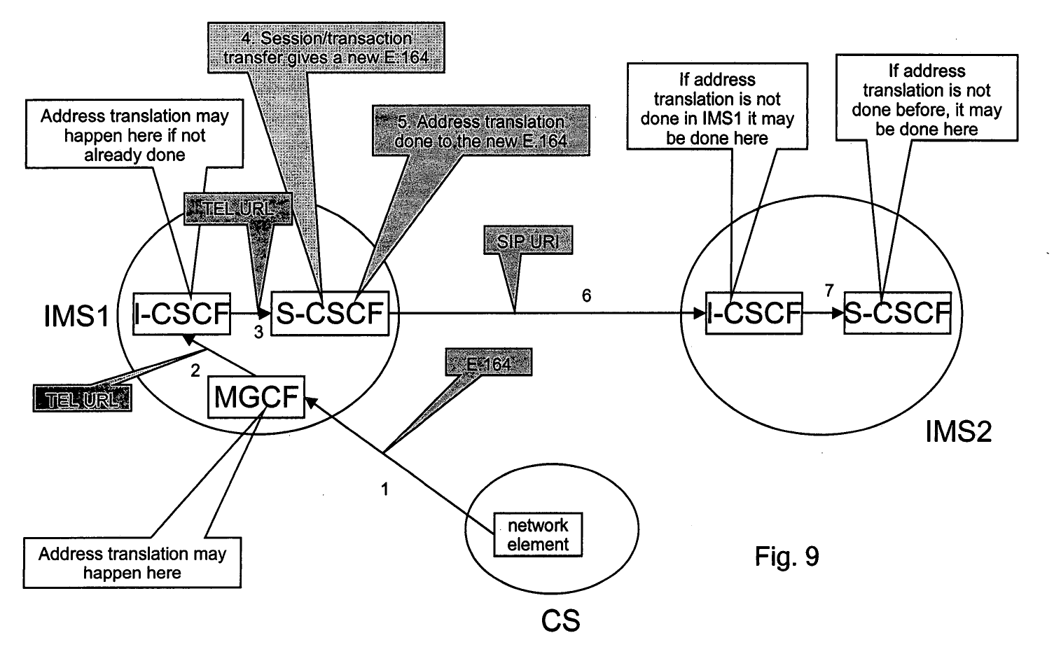

FIG. 9 shows a routing example in case of a call transfer. Similarly as shown in FIG. 7, at the S-CSCF of IMS1 a new E.164 number is obtained, in this case because of a call transfer. Hence, address translation of the new E.164 number according to the invention may be done in the S-CSCF of IMS1.

FIG. 10 shows a routing example in which address translation according to the invention is done in the terminating network IMS2. As shown in FIG. 10, in the S-CSCF of IMS1 it is detected that the call has to be forwarded to a new E.164 number. In this example, no address translation is done in IMS1, but the call is routed to IMS2 using TEL URL which is an optimization when IMS1 and IMS2 are the same network. Because address translation is not done in IMS1 it is done in the I-CSCF or S-CSCF of IMS2. In case the I-CSCF of IMS2 performs the address translation according to the invention, the call is routed towards the S-CSCF using SIP URI. The further components and processes of FIG. 10 correspond to those in FIG. 7.

FIG. 11 shows an example of routing a call via CS network. A call present in IMS1 network has to be routed to CS since it cannot be routed via IMS because there is no answer from ENUM, for example. In other words, the S-CSCF or BGCF of IMS1 are not able to translate the address to SIP URI. Hence, the call is routed from S-CSCF to MGCF via BGCF using TEL URL and from MGCF to a CS network node using E.164. At this or another CS network element the E.164 number is routed further to an MGCF of IMS2 which MGCF performs the address translation of E.164 according to the invention. Then, the call is routed further using SIP URI. Alternatively, the I-CSCF or S-CSCF of IMS2 may perform the address translation so that in this case the call is routed to the I-CSCF or S-CSCF using TEL URL.

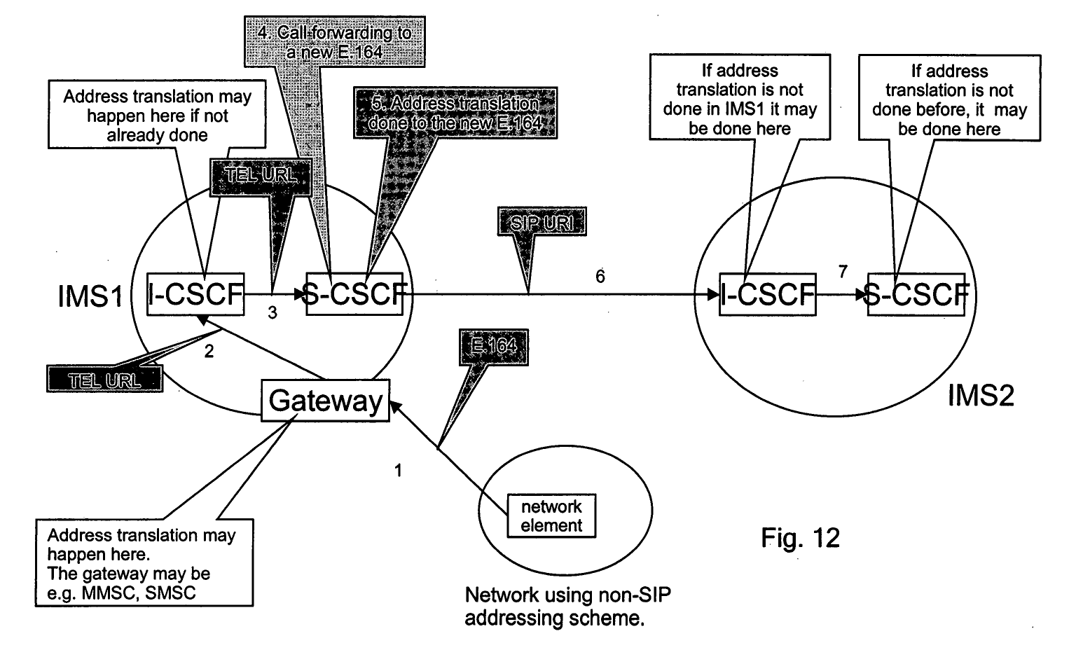

FIG. 12 shows a more general example for forwarding a call initiated by a network element located in a network using non-SIP addressing scheme towards a network IMS1. As shown in FIG. 12, the call is routed to a gateway interfacing the non-SIP network and IMS1. The gateway may be an MMSC or SMSC, for example. The address translation according to the invention may be done at this gateway node. The further components and processes of FIG. 12 correspond to those in FIG. 7.

It is to be noted that in FIGS. 7 to 12 only such network elements are shown which are necessary for describing the routing examples. Moreover, in all cases shown in FIGS. 7 to 12 the IMS1 and IMS2 can be the same network.

It is an advantage of the present invention that, in principle, only one NAPTR resource record is required for the whole number range while every number would need an own NAPTR if the ENUM translation result was a pure SIP URI.

When the result is a pure SIP URI, NAPTR DNS resource records are needed for numbers 35840223344, 35840223345, 35840223346 and 35840223347, for example. Any other number needs a similar record. $ORIGIN 4.3.3.2.2.0.4.8.5.3.e164.arpa.

4 IN NAPTR 10 10 “u” “sip+E2U” “!\hat{ }.*$!sip:john.smith@ims.operator1.fi!”.

5 IN NAPTR 10 10 “u” “sip+E2U” “!\hat{ }.*$!sip:joan.brown@ims.operator1.fi!”.

6 IN NAPTR 10 10 “u” “sip+E2U” “!\hat{ }.*$!sip:jill.wayne@ims.operator1.fi!”.

7 IN NAPTR 10 10 “u” “sip+E2U” “!\hat{ }.*$!sip:george.doe@ims.operator1.fi!”.

When this invention is applied i.e., the result of the ENUM translation is such that the original number can be extracted, only the following single NAPTR DNS resource record is needed to translate for example all E.164 numbers of the range 35840220000-35840229999. $ORIGIN 2.2.0.4.8.5.3.e164.arpa.

* IN NAPTR 10 10 “u” “sip+E2U” “!(\hat{ }.*$)!sip:\1@ims.operator1.fi;user=phone!”

Actually this single NAPTR can be used to translate all numbers 3584022* where “*” is a wildcard matching whatever amount of whatever numbers.

E.164 number is carried as TEL URL in SIP (see RFC3261 and RFC2806). For example tel:+35840223344 is the corresponding TEL URL of the E.164+35840223344. Thus E.164 can always be extracted from the corresponding TEL URL. Because of generality E.164 is used consequently in the text and figures of this invention instead of TEL URL even if referring to TEL URL representation of the E.164 in case of SIP.

Instead of ENUM E.164 can be translated to SIP URI simply appending @ sign and a domain name as well as “user=phone” parameter and adding “sip:” as prefix. For example +35840223344 becomes sip:+35840223344@ims.operator1.fi. This kind of simplified translation to SIP URI can be done when the domain name is known. For example, it can be applied instead of utilizing configured routing from MGCF to I-CSCF, or when routing from an originating S-CSCF to an I-CSCF in the same network.

It is to be understood that the above description is illustrative of the invention and is not to be construed as limiting the invention. Various modifications and applications may occur to those skilled in the art without departing from the true spirit and scope of the invention as defined by the appended claims.

What is claimed is:

1. A method of implementing interworking of addressing schemes in a communication network using at least two different addressing schemes the method comprising the steps of:
obtaining a first address according to a first addressing scheme;
providing a second address according to a second addressing scheme by including the first address into the second address such that the first address is represented in the second address; and
providing an indication that part of the second address represents the first address.

2. The method according to claim 1, further comprising the step of:
upon a query on the basis of an address according to the first addressing scheme, returning a corresponding address formed according to the second addressing scheme and the indication that part of the address according to the second addressing scheme represents the corresponding address according to the first addressing scheme.

3. The method according to claim 1, further comprising the step of:
upon a query on the basis of an address according to the first addressing scheme, returning a corresponding address formed according to the second addressing scheme and adding thereto the indication that part of the address according to the second addressing scheme represents the corresponding address according to the first addressing scheme.

4. The method according to claim 2, wherein the address returning step is performed by using ENUM translation.

5. The method according to claim 3, wherein the address returning step is performed by using ENUM translation.

6. The method according to claim 1, wherein the indication is part of the second address.

7. The method according to claim 1, wherein the indication is ‘user=phone’ tag.

8. The method according to claim 1, wherein the first address is obtained in an ISUP message.

9. The method according to claim 1, wherein the second address is a SIP URI.

10. The method according to claim 1, further comprising the step of:
sending the second address further in a first signaling message.

11. The method according to claim 10, further comprising the steps of:
receiving at least one responding signaling message in response to the first signaling message; and
detecting in the received message an indication that the message includes an address according to the second addressing scheme which includes an address that can be presented according the first addressing scheme.

12. The method according to claim 11, further comprising the step of:
extracting said address according to the first addressing scheme out of said address according to the second addressing scheme.

13. The method according to claim 12, further comprising the step of:
sending the extracted address in a second signaling message.

14. The method according to claim 11, wherein the first and responding signaling messages are SIP messages.

15. The method according to claim 13, wherein the second signaling message is an ISUP message.

16. The method according to claim 12, wherein the extracted address is an address of a connected user.

17. The method according to claim 1, wherein the first address is an address according to the E.164 addressing scheme.

18. The method according to claim 12, wherein the extracted address is an address according to the E.164 addressing scheme.

19. A network node for implementing interworking of addressing schemes in a communication network using at least two different addressing schemes, the network node comprising:
means for obtaining a first address according to a first addressing scheme;
means for providing a second address according to a second addressing scheme by including the first address into the second address such that the first address is represented in the second address, and for providing an indication that part of the second address represents the first address.

20. The network node according to claim 19, wherein said means for providing a second address comprise:
means for performing a query on the basis of the obtained first address; and
means for receiving, upon the query, a corresponding address formed according to the second addressing scheme and the indication that part of the address according to the second addressing scheme represents the corresponding address according to the first addressing scheme.

21. The network node according to claim 19, wherein said means for providing a second address comprise:
means for performing a query on the basis of the obtained first address; and:
means for receiving, upon the query, a corresponding address formed according to the second addressing scheme; and
means for adding to the returned address the indication that part of the address according to the second addressing scheme represents the corresponding address according to the first addressing scheme.

22. The network node according to claim 20, wherein the means for providing the second address are arranged to provide the second address by using ENUM translation.

23. The network node according to claim 19, wherein the indication is part of the second address.

24. The network node according to claim 19, wherein the indication is ‘user=phone’ tag.

25. The network node according to claim 19, wherein the obtaining means is arranged to obtain the first address in an ISUP message.

26. The network node according to claim 19, wherein the second address is a SIP URI.

27. The network node according to claim 19, further comprising:
means for sending the second address further in a first signaling message.

28. The network node according to claim 27, further comprising:
means for receiving at least one responding signaling message in response to the first signaling message; and
means for detecting in the received message an indication that the message includes an address according to the second addressing scheme which includes an address that can be presented according the first addressing scheme.

29. The network node according to claim 28, further comprising:
means for extracting said address according to the first addressing scheme out of said address according to the second addressing scheme.

30. The network node according to claim 29, further comprising:
means for sending the extracted address in a second signaling message.

31. The network node according to claim 27, wherein the first and responding signaling messages are SIP messages.

32. The network node according to claim 30, wherein the second signaling message is an ISUP message.

33. The network node according to claim 29, wherein the extracted address is an address of a connected user.

34. The network node according to claim 19, wherein the first address is an address according to the E.164 addressing scheme.

35. The network node according to claim 29, wherein the extracted address is an address according to the E.164 addressing scheme.

36. The network node according to claim 19, wherein the network node is a MGCF.

37. The network node according to claim 19, wherein the network node is acting as at least one of an MGCF, a BGCF, an application server, a multimedia message service center and short message service center.

38. A communication network comprising at least two subnetworks, at least one network node in each subnetwork, at least one user in each subnetwork and a gateway node interfacing the at least two subnetworks,
wherein a first subnetwork uses a first addressing scheme routable in the first subnetwork;
a second subnetwork uses a second addressing scheme routable in the second subnetwork; and
the gateway node is configured to:
obtain a first address according to the first addressing scheme,
provide a second address according to the second addressing scheme by including the first address into the second address such that the first address is represented in the second address and
provide an indication that part of the second address represents the first address.

39. A communication network according to claim 38, wherein said gateway node provides the second address using ENUM translation.

40. A communication network according to claim 38, further comprising an address translation node, wherein said gateway node is configured to use the address translation node when providing the second address.

41. A communication network according to claim 40, wherein said address translation node is configured to perform the address translation using ENUM translation.

42. A communication network according to claim 38, wherein said gateway node is further configured to receive the first address in a signaling message from the first subnetwork.

43. A communication network according to claim 38, wherein said gateway node is further configured to send the second address in a signaling message to the second subnetwork.

44. A communication network according to claim 38, wherein a user of the second subnetwork is configured to send, in response to a received initiating signaling message, the connected address in a response signaling message.

45. A communication network according to claim 38, wherein a network node of the second subnetwork is configured to control a user of the second subnetwork, an to send, in response to a received initiating signaling message to the user, the address of the user in a response signaling message.

46. A communication network according to claim 38, wherein said gateway node is further configured to receive a signaling message from the second subnetwork and to detect in said received message an indication that the message includes an address according to the second addressing scheme which includes an address that can be presented according the first addressing scheme.

47. A communication network according to claim 46, wherein said gateway node is further configured to extract said address according to the first addressing scheme out of said address according to the second addressing scheme.

48. A communication network according to claim 46, wherein said gateway node is further configured to send the extracted address in a signaling message to the first subnetwork.

49. A communication network according to claim 38, wherein said gateway node is a network node of either subnetwork.

50. A communication network according to claim 38, wherein said gateway node is a CSCF of either subnetwork.

51. A communication network according to claim 38, wherein said gateway node is acting as at least one of an MGCF, a BGCF, an application server, a multimedia message service center and short message service center.
